(19) United States
(12) Patent Application Publication
(10) Pub. No.: US 2016/0376190 A1
(43) Pub. Date: Dec. 29, 2016

(54) METHOD FOR PRODUCING A SUBSTRATE COMPRISING A TEXTURED GLASS-BASED COATING AND A COATED SUBSTRATE

(71) Applicants: Schott Orim Cam Sanayi ve Ticaret A.S, Çerkezkoey (TR); Schott AG, Mainz (DE)

(72) Inventors: Hueda Karagoez, Corlu/ Tekirdag (TR); Stephanie Mangold, Mainz (DE); Carsten Schwabe, Horbach (DE); Silke Knoche, Saulheim (DE)

(73) Assignees: Schott Orim Cam Sanayi ve Ticaret A.S, Çerkezkoey (TR); Schott AG, Mainz (DE)

(21) Appl. No.: 15/190,490

(22) Filed: Jun. 23, 2016

(30) Foreign Application Priority Data
Jun. 24, 2015 (DE) 102015110121.1

(51) Int. Cl. C03C 17/00; C03C 17/04

(52) U.S. Cl. CPC C03C 17/007; C03C 17/04; C03C 17/002

(57) ABSTRACT

A method is disclosed for preparing a substrate with a coating from a paste comprising the following steps: (a) providing a substrate; (b) preparing a paste from a glass frit to which ferromagnetic pigments and a flux agent are admixed; (c) applying the paste onto a surface of the substrate; (d) aligning the paste by means of a magnetic field; and (e) burning-in of the paste.

### CROSS REFERENCES TO RELATED APPLICATIONS

This application claims priority from German patent application 10 2015 110 121.1, filed on Jun. 24, 2015. The entire content of this priority application is incorporated herein by reference.

### BACKGROUND OF THE INVENTION

The invention relates to a method for producing a substrate comprising a textured glass-based coating, as well as a coated substrate. A textured coating in the scope of this application will be understood as a coating comprising a texture, i.e. the coating is not homogeneous, but has a texture of any kind, thus has at least one characteristic depending on direction. Preferably, this is an optically conceivable characteristic, which also includes an optical 3D-effect. The surface of the coating may preferably be smooth, so that the texture at the surface of the coating is not developed plastically.

It is known that anorganic, glass-based coatings impart particular characteristics to the surfaces of glass and glass ceramics.

The glass proportion of the coating imparts particular chemical and physical characteristics to the coating. This may for instance be chemical resistance, abrasive and scratch resistance, as well as thermal stability. When compared with coatings of organic matrix, the anorganic coatings distinguish by an increased gloss and a higher resistance against UV-radiation. The addition of color-providing pigments or tarnish additives allows to design the coated article with respect to esthetics and design and to differentiate it. Planar coatings often serve to protect the coating or to generate a particular appearance, such as full-surface coatings on operational shades for ovens, as frames for chimney panes, prefix panes for ovens. Decorations are used for inscriptions, logos, for generating a desired design and also to assist particular technical functions, such as in the case of display windows or as markings of cooking zones. Cooking surfaces made of glass ceramic on the surface are designed colored, partially due to esthetic reasons, partially for differentiating the product manufacturer, as well as due to particular statutory demands, such as a marking of cooking zones. Due to the high temperatures at the cooking surface, in particular within the cooking zones, that are up to about 700° C., depending on the heating system and the cooking situation, as well as to the necessary demanded utility characteristics, almost only glass-based coatings are utilized for the color design.

Glass-based coatings usually are divided into the category glazes or enamels (also called enamels). The glazes usually consist of a clear or colored glass, while enamels are coating materials containing coloring, non-transparent materials, such as pigments. Colored, anorganic compositions may be utilized as pigments. The coating process itself usually is called glazing, enameling, decorating or printing.

Glass-based coatings also have been used since a long time for the coating of metals and ceramics. With such coatings it is possible and it is desired to match the coefficients of thermal expansion of the coating and of carrying material in a good way. Thereby higher coating thicknesses are made possible which increase the protection effect and the design possibilities.

For the coating of glass and glass ceramics technically mature methods and equipment are in use. Coating methods dominate, wherein a liquid or pasty, respectively, coating material is applied. This paste or ink can be applied by means of different methods, such as screen printing, tampon printing, transfer picture methods, offset printing, roll printing, applying by doctor-blade, flooding, spin-coating, as well as dipping and spraying methods, lately also by ink-jet printing, onto the surface of the substrate.

The paste usually consists of ground glass powder (also called glass frit), to which usually pigments are added, optionally further anorganic additives and a flux agent (in particular screen printing oil), and possible further organic additives that during burning-in and smooth flowing of the coating fully evaporate.

Due to the particular demands that are required from glass-based coatings of glass and glass ceramics, the components of the glass usually initially are fully molten and then ground to a glass frit of suitable particle-size.

To generate particular structures, in particular 3D-structures, i.e. at least partially plastic structures, on a surface of a substrate, in particular an application by means of various printing methods is possible, wherein by a multiple application also a somewhat plastic structure could be reached. However, it poses a problem that during burning-in the structures possibly may melt down again. In addition, a maximum layer thickness may not be exceeded, since this leads to a chipping off of the burnt-in coating. In addition, such a method in the case of multiple applications is very complex.

### SUMMARY OF THE INVENTION

In view of this the invention is a first object of the invention to disclose a cost-effective method for the generation of textured, glass-based coatings on a surface of a substrate.

It is a second object of the invention to disclose a method for the generation of textured, glass-based coatings on a surface of a substrate that allows to provide a coating that is visible, in particular a 3D-coating.

It is a further object of the invention to disclose a method for the generation of textured, glass-based coatings on a surface of a substrate that allows to provide a coating that is visible, however without providing a 3D-effect on a top side of the substrate.

It is a still further object of the invention to disclose a coated substrate comprising a textured surface.

According to one aspect of the invention these and other objects are solved by a method for preparing a substrate with a textured coating from a paste, comprised in the following steps:
providing a substrate;
preparing a paste from a glass frit to which ferromagnetic pigments and a flux agent are admixed, wherein a solid proportion of the paste comprises at least 5 wt.-% up to a maximum of 60 wt-% of ferromagnetic pigments;
applying the paste onto a surface of the substrate;
aligning the paste by means of a magnetic field; and
burning-in the paste.

By aligning the ferromagnetic pigments within the paste by means of a magnetic field in this way simple structures with a texture, in particular also optically visible 3D-effects, including plastic structures or 3D-structures, can be generated by means of the magnetic field lines. Due to the magnetic field the ferromagnetic pigments align along the field lines and thus generate a different optical appearance than the non-treated region. After switching off the magnetic field the pigments remain in the aligned state and during a subsequent burning-in generally remain in this alignment, so that a texture results. A 3D-effect can be generated which is well visible from the glass side, wherein the coating at the surface may have no or only a very small plastic appearance. An optically visible 3D-effect herein may reached by brighter and darker regions due to the alignment of the ferromagnetic pigments.

Since a solid proportion of the paste comprises at least 5 wt.-% up to a maximum of 60 wt.-% of ferromagnetic pigments, it is ensured that on the one hand an alignment of the ferromagnetic pigments with a magnetic field is made possible and, on the other hand, the proportion of ferromagnetic pigments is not so high that a clear melting (smooth melting) of the coating is impaired during burning-in.

Depending on the magnet that is used for aligning, the texture of the coating may be influenced. In particular by means of electromagnets the alignment of the texture can be influenced or varied, respectively, in a wide range.

Thus for instance with special shapes of the magnets different patterns, such as rings, logos, graphic characters, can be generated. Also by means of programmable magnets various characters can be generated.

The application time of the magnets may be a fracture of a second up to several minutes. Preferred is an application time of 0.5 to 5 seconds.

The distance of the magnet depends from the impinging side (acting on the lower side—opposite to the coating, acting on the top side), the substrate thickness and the respective color paste and may be individually determined by the skilled person. The distance on the opposite side of the coating may be between 0 mm (direct abutment at the substrate) up to 10 mm. The distance from the top side should be between 1 and 15 mm for protecting the magnet against contamination.

Preferably iron-containing pigments are added as ferromagnetic pigments which may further comprise O, Mn, Cr, Co, Ni, Zn and/or Ti.

Preferably iron-containing ferromagnetic pigments are used which preferably may originate from the following color-index-groups (C. I.):
Black 26—(Fe, Mn)(FeMn)₂O₄-based, preferably configured as spinel;
Black 27—Co(Cr, Fe)₂O₄-based, preferably spinel-based;
Black 30—(Ni, Fe)(Cr, Fe)O₄-based, preferably spinel-based;
Read 101—Fe₂O₃.

As particularly suitable the ferromagnetic pigments from the color index groups Black 26 and Black 30 have been found.

Surprisingly it was found that not all iron-containing pigments are ferromagnetic. Thus pigments which contain the same metal oxides (e.g. iron-manganese oxides) for instance due to different crystal structures may be ferromagnetic or non-ferromagnetic. Thus it was found that pigments based on (Fe, Mn)(FeMn)₂O₄ were ferromagnetic, while a pigment based on (Mn, Fe)₂O₃ was non-ferromagnetic. Examples for C. I. groups that showed no ferromagnetism were Black 33 and Brown 29.

As described on the website of SDC (Society of Dyers and Colourists) and of the American Association of Textile Chemists and Colorists, the Color Index (briefly C. I.) serves to characterize all usable color agent chemicals and color agent base chemicals. The C. I. is a reference work of all usable color agent and color agent base chemicals existing since 1925 and is considered to be the standard work on the field of the pigment and color agent chemistry issued by the British Society of Dyers and Colourists and American Association of Textile Chemists and Colorists. The color index in the pigment and color agent industry is used trademark independently, specifically the C. I.-name as the common term for characterization.

According to a further configuration of the invention in addition color-providing pigments, fillers and/or structure-providing particles may be admixed to the paste.

Thereby in particular the color of the coating as well as further characteristics of the coating can be influenced.

According to a further configuration of the invention color-providing pigments in the form of metal oxides are added to the paste, which in particular may generate black, grey, white, blue, green, yellow, orange, red, pink, as well as brown colors.

The metal oxides may be selected from the group consisting of cobalt oxides/spinets, cobalt-aluminum-spinels, cobalt-aluminum-zinc-oxides, cobalt-aluminum-silicon-oxides, cobalt-titanium-spinels, cobalt-chromium-spinels, cobalt-aluminum-chromium-oxides, cobalt-nickel-manganese-iron-chromium-oxides/spinels, cobalt-nickel-zinc-titanium-aluminum-oxides/spinels, chromium-iron-nickel-manganese-oxides/spinels, cobalt-iron-chromium-oxides/spinels, nickel-iron-chromium-oxides/spinels, iron-manganese oxides/spinels, iron-oxides, iron-chromium-oxides, iron-chromium-tin-titanium-oxides, copper-chromium-spinels, nickel-chromium-antimony-titanium-oxides, titanium-oxides and zirconium-silicon-iron-oxides/spinels, and mixtures thereof.

Preferably in addition pigments configured as absorption pigments, in particular also plate-shaped or pin-shaped pigments, coated effect pigments are utilized which may be added to the paste as individual pigments or pigment mixture.

In addition various additives may be added which preferably are selected from the group consisting of SiOₓ-particles, aluminum oxide particles, pyrogenic silicic acids, lime soda-, alkaline alumino-silicate- and borosilicate glass spheres, hollow glass spheres, polysiloxane spheres, and/or mixtures thereof.

Preferably the following glass types are utilized as glass frits: alkaline-free and alkaline-containing glasses, silicate glasses, borosilicate glasses, zinc-silicate glasses, zinc-borate glasses, zinc-borosilicate glasses, bismuth-borosilicate glasses, bismuth-borate glasses, bismuth-silicate glasses, phosphate glasses, zinc-phosphate glasses, alumino-silicate glasses, or lithium-alumino-silicate glasses. Depending on the firing condition and the carrying material (substrate) the person skilled in the art will select a suitable glaze glass, in particular with respect to ensuring that with a suitable glaze thickness a melting start and a full melting of the paste is ensured. The glass frit is preferably free of elements such as Pb and Cd.

This means that the softening temperature E_{W} of the glass frit is below the burning-in temperature. The duration of the burning-in may be between a few minutes and several hours, depending on the temperature program that is used.

In particular the burning-in preferably is performed in combination and preferably during a thermal pre-stressing of a flat pane glass substrate. Herein the maximum values of the temperature are between 680° C. and 720° C. Thereafter active cooling follows.

Preferred compositions of glass frits for the coating of glass ceramic-substrates and glass substrates are subsequently summarized in tables 1 and 2.

TABLE 1
Preferred glass frit compositions for coatings on glass ceramic substrates

| wt.-% | glass A | glass B | glass C | glass D | glass E | glass F | glass G | glass H | glass I |
|---|---|---|---|---|---|---|---|---|---|
| SiO₂ | 44-57 | 53-63 | 57-62 | 47-52 | 40-50 | 63-73 | 50-66 | 45-60 | 45-75 |
| Al₂O₃ | 5-25 | 15-25 | 5-8 | 2-6 | 9-15 | 0-7 | 0-20 | 6-17 | 1-10 |
| B₂O₃ | 0-27 | 15-22 | 18-23 | 17-21 | 10-15 | 12-29 | 0-8 | 0-10 | 10-30 |
| Li₂O | 0-10 | 2-7 | 2-6 | 3-5 | 0-4 | 0-6 | 0-12 | 0-7 | 0-5 |
| Na₂O | 0-10 | 0-1 | 0-1 | 1-5 | 1-4 | 0-8 | 7-15 | 0-7 | 0-10 |
| K₂O | 0-10 | 0-1 | 0-4 | 5-10 | 0-3 | 0-8 | 0-3 | 0-7 | 0-5 |
| CaO | 0-4 | 1-4 | 1-2 | 0-2 | 0-3 | 0-5 | 0-10 | 0-12 | 0-4 |
| MgO | 0-3 | 1-4 | 0-2 | 0-1 | 0-3 | 0.1-5 | 3-8 | 0-9 | 0-4 |
| BaO | 0-4 | 0-1 | 0-2 | 0-2 | 16-24 | 0-5 | 0-15 | 13-27 | 1-10 |
| SrO | 0-4 | 1-4 | 0.5-2 | 0-1 | 0-2 | 0-4 | 0-4 | 0-4 | 0-4 |
| ZnO | 0-15 | 1-4 | 0-2 | 0-3 | 8-15 | 0-15 | 0-5 | 3-17 | 0-20 |
| TiO₂ | 0-3 | 0-1 | 0-2 | 0-2 | 0-3 | 0-5 | 0-5 | 0-2 | 0-2 |
| ZrO₂ | 0-7 | 1-4 | 2-5 | 0-2 | 0-4 | 0-5 | 0-5 | 0-7 | 0-7 |
| As₂O₃ | 0-1 | 0-1 | 0-1 | 0-1 | 0-1 | 0-1 | 0-1 | 0-1 | 0-1 |
| Sb₂O₃ | 0-15 | 0-1 | 0-1 | 0-1 | 0-15 | 0-1 | 0-1 | 0-1 | 0-1 |
| F | 0-3 | 0-1 | 0-1 | 0-1 | 0-1 | 0-1 | 0-1 | 0-1 | 0-2 |

TABLE 2
Preferred glass frit compositions for coatings on glass substrates

| wt.-% | glass K | glass L | glass M | glass N | glass O | glass P |
|---|---|---|---|---|---|---|
| SiO₂ | 25-55 | 35-65 | 30-54 | 6-20 | 6-15 | 45-65 |
| Al₂O₃ | 3-18 | — | 0-17.5 | 0-5 | — | 0-15 |
| B₂O₃ | 5-25 | — | 13-28 | 20-38 | 20-28 | 5-30 |
| Li₂O | 0-12 | 0-6 | 3-6 | — | — | 0-10 |
| Na₂O | 3-18 | 0-6 | 4-10 | — | — | 0-10 |
| K₂O | 3-18 | 0-6 | 0-2 | — | — | 0-10 |
| CaO | 3-17 | 0-12 | 0-6 | — | — | 0-5 |
| MgO | 0-10 | 0-12 | 0-4 | — | — | 0-5 |
| BaO | 0-12 | 0-38 | — | — | — | 0-20 |
| SrO | — | 0-16 | 0-4 | — | — | 0-16 |
| ZnO | — | 17.5-38 | 3-13 | 35-70 | 58-70 | 0-35 |
| TiO₂ | 0-5 | — | 0-2 | 0-5 | — | 0-5 |
| ZrO₂ | 0-3 | — | 0-2 | 0-5 | — | 0-5 |
| Bi₂O₃ | — | — | — | 0-20 | — | 0-20 |
| CoO | — | — | — | 0-5 | — | — |
| Fe₂O₃ | — | — | — | 0-5 | — | — |
| MnO | — | — | — | 0-10 | 0.5-1 | — |
| CeO₂ | — | — | — | — | 0-3 | — |
| F | — | — | 0-3.3 | 0-6 | — | — |

As already mentioned, pigments, pigment mixtures, fillers and structure-providing particles may be added to the paste individually and/or as mixtures. The particle size of the pigments, fillers, and particles may be in the nm-range and μm-range, preferably with a D90-value between 1 nm and 100 μm, particularly preferred with a D90-value between 10 nm and 50 μm, particularly preferred with D90-values between 20 nm and 10 μm.

The particle sizes are determined using a laser dispersion method (CILAS 1064, wet dispersion).

Particularly preferred the paste comprises a solid proportion which is between 5 wt.-% and a maximum of 60 wt.-%, preferably between 10 wt.-% and 45 wt.-%, particularly preferred between 15 and 35 wt.-% of ferromagnetic pigments.

A certain minimum proportion is necessary to allow a noticeable aligning of the paste by an applied magnetic field. On the other hand the proportion of ferromagnetic pigments may not be so high that a clear melting (smooth melting) of the coating is impaired during burning-in.

Particularly good results were obtained using a proportion of magnetic pigment from 15 to 25 wt.-% of solid proportion of the paste.

An important parameter when preparing the paste is the viscosity that is adjusted that generally is determined by the flux agent added in liquid form (such as screen printing oil). On the one hand the viscosity must be sufficiently low so that the ferromagnetic pigments may align under the force of magnetic fields, on the other hand the viscosity or thixotropy, respectively, must be sufficiently high to conserve the plastic structure of the paste and to avoid a blurring of the structure during the subsequent process steps, in particular during burning-in.

To allow an alignment of the pigments, the viscosity of the paste must be adjusted thereto. The viscosity preferably lies in the range of 1 to 2000 cP at 140 rpm, preferably in the range of 10 to 1000 cP, further preferred in the range of 50 to 800 cP. Particularly good results are obtained with a viscosity in the range of 100 to 600 cP.

The layer thicknesses of the burnt-in ceramic coatings on the substrates may be between 0.5 and 50 μm, preferably between 1 and 20 μm, particularly preferred between 1 and 10 μm. The coatings may be full-surface or also locally, configured as structured decorations such as grids, patterns, graphic characters, symbols, etc. applied as a single layer, or there may be several coatings (colors) adjacent to each other or one over the other.

Although the coating may basically be used on other substrates, such as metals or ceramics, particular advantages result, when a glass or glass ceramic substrate is used as a substrate.

Also the substrates may consist of composite materials or reinforced, or fiber-enforced, respectively, materials. Preferably glasses and glass ceramics are used which are transparent, colored transparent, translucent or opaque. The glasses or glass ceramics may be equipped with additional functions, such as chemical or thermal hardening, functional coatings, such as anti-scratching or easy-to-clean characteristics.

As far as glass ceramics are used as substrates, these preferably may be provided in the green glass condition and may be ceramized during the burning-in procedure (i.e. crystallized). This leads to a particularly simple and cost-effective process design.

Alternatively naturally also glass ceramics may be utilized in the already ceramized state which are coated with the paste and burnt-in thereafter.

The substrate may be of any shape and size. It may be a planar substrate, a substrate to be bent, or an already (partially) bent substrate. The preferred thickness of the substrate is 0.02 to 100 mm, preferably 2 to 6 mm, particularly preferred 3.5 to 4.5 mm. The substrates may comprise mechanically processed or etched surfaces, as well as local indentations and/or elevations. The substrate also may have thicknesses that vary locally. Preferably substrates are used such as used in the range of white products or household appliances, for instance for baking and cooking devices, microwave ovens, refrigerators, steam cookers, operating shades for such devices, gas cooking devices, sinks, dishwashers, cooking surfaces, furnace panes, chimney viewing panes etc.

Also coatings (colors) may be present on the substrate top surface and/or bottom surface. Coatings on ceramic, sol-gel, silicon, polymer basis etc., may be used individually, or in combination.

The application of the coatings may preferably be done by liquid coating methods such as screen printing, ink-jet printing, offset printing, tampon printing, spraying methods, dip-coating, roll coating, doctor-blade, flooding, spin-coating. The necessary additives, which are usually organic, evaporate during burning-in of the coating.

According to a further design of the invention the coating is made as a screen-printing color made on sol-gel-basis.

According to a further development of the invention the coating after application onto the surface of the substrate is aligned by means of a magnetic field and dried thereafter, before the burning-in of the coating is performed.

Thereby an improved fixation of the structure generated by the magnetic field is made possible.

According to a further development of the invention the coating after its application onto the surface of the substrate is aligned by means of the magnetic field and is simultaneously dried, before the burning-in of the coating is performed.

By using simultaneous drying an even better conservation of the structure against a blurring during subsequent burning-in can be ensured.

An alternative possibility is to provide the paste with UV-hardening additives which are hardened by means of UV-irradiation during or after the aligning of the coating by means of the magnetic field.

The temperature during burning-in is adjusted in a suitable way to reach a smooth flowing of the paste during burning-in. In any event the temperature during burning-in is above the softening temperature of the glass frit.

The burning-in of the paste usually is performed at temperatures which are below the softening range of the substrate, but are sufficiently high to ensure a smooth melting of the glaze and an intimate joining with the surface of the substrate. One possibility for the preparation of glazes is the melting of glaze raw materials to yield a glass that after melting and cooling is ground. The ground product is designated as a glass frit. Such a glass frit usually is mixed with suitable additives, such as flux agents or suspending agents which assist the application of the paste. The color-providing pigments can be added to the glaze raw material or may preferably be mixed with the ground glass frit and homogenized therewith,

For grinding the glass frit different dry and wet grinding technologies can be utilized, such as ball mills, jet grinding, in particular counter-jet, air-jet or stream-jet grinding.

The object of the invention in addition is solved by a substrate comprising a burnt-in coating of a paste that comprises magnetizable pigments being structured by means of a magnetic field, preferably in a plastic way.

In addition also a utilization of ferromagnetic pigments for preparing a paste for coating of a substrate is disclosed that are alignable by means of magnetic field, so that the alignment during a subsequent burning-in of the coating is generally preserved.

It should be understood that the afore-mentioned features and the features of the invention to be mentioned hereinafter cannot only be used in the combination respectively given, but also in different combinations or independently, without leaving the scope of the invention.

Further features and advantages of the invention can be taken from the subsequent embodiments.

### EXAMPLES

### Example 1

For preparing a black paste with a viscosity of 500 cP at 140 rpm 40 g of a ground glass frit (glass N, particle size D90 <4 μm) was mixed with 10 g black pigment (Black 27) and with 100 g of commercially available screen printing oil. This paste was applied onto a 4 mm thick pane of Borofloat® (trademark of the company Schott AG, Mainz) with a size of 200 mm×200 mm in full-surface using screen-printing. An electromagnet having the shape of a square of 50 mm×50 mm now was held onto the uncoated side of the glass, and the pigment aligned in this region. Thereafter the coated substrate was dried at 200° C. and was burnt-in at 650° C. for 10 min.

The layer thickness was 3.2 μm, the burnt-in paste was black and in the region, where it was treated with a magnet, was clearly visible as a grey square.

### Example 2

For preparing a red paste with a viscosity of 105 cP at 140 rpm 40 g of a ground glass frit (glass A, particle size D90 <4 μm) was mixed with 10 g of read pigment (Read 101) and with 100 g of commercially available screen-printing oil. This coating was applied full-surface onto a 4 mm thick pane of glassy CERAN Cleartrans® (trademark of the company Schott AG, Mainz) having a size of 200 mm×200 mm using screen printing. A permanent magnet having the shape of a circle with 50 mm diameter now was held against the non-coated of the glass, and the pigment aligned in this region. Thereafter the coated substrate was dried at 200° C. Thereafter the paste was burnt-in simultaneously with ceramizing the substrate at 900° C.

The layer thickness was 2.6 μm, the burnt-in paste was read, and in the region, where it was treated with a magnet, was clearly visible as an elevated circle.

### Example 3

For preparing a UV-pre-dried black paste with initial viscosity of 227 cP at 140 rpm 40 g of a ground glass frit (glass A, particle size D90 <4 μm) was mixed with 20 g of black pigment (Black 26) and 100 g of an acrylate-containing screen printing oil (UV-direct printing medium). This paste was applied full-surface onto a 4 mm thick pane of glassy CERAN Cleartrans® (trademark of the company Schott AG, Mainz) having a size of 200×200 mm² by means of screen-printing. A permanent magnet that carried the shape of a lettering was now held against the non-coated side of the glass which lead to the aligning of the coating in this region. Thereafter the coated substrate was hardened by means of UV light for 10 seconds. The UV-dried coating had a thickness of 7.8 μm. The burning-in of the coating was performed simultaneously with the ceramization of the substrate at 920° C. for 15 minutes.

The layer thickness was 3.1 μm, the burnt-in paste was black, and in the region, where it was treated with a magnet, the optically elevated lettering with 3D-appearance was clearly visible.

### Example 4 (Sol-Gel-Paste)

0.21 mol of MPTES (methacryl-oxypropyl-triethoxy-silane) and 0.05 mol of TEOS (Tetraethoxysilane) was mixed with water and hydrolyzed. 50 g of this hydrolysate together with a mixture of 44 g of an alcoholic dispersion (30 wt.-%) of sphere-shaped SiO₂ nano-particles with a diameter of 40-50 nm in isopropanol were put together with 11 g of an alcoholic dispersion of sphere-shaped SiO₂ nano-particles with a diameter of 10 to 15 nm. To this solution 16 g of diethylene-glycol-mono-ethylether were added and the easily evaporative solvent was removed at 100 mbar at 50° C. bath temperature at a rotary evaporator.

To the coating solution thereafter 2.63 g of diethylene-glycole-monoethylether, 0.42 g of a radical UV-starter Irgacure 819, 0.04 g BYK 307 and 30 g of ferromagnetic black pigment Black 27 were added. The solution was stirred for 10 minutes.

After full mixing of the coating solution a full-surface layer was applied onto a lime-soda-glass by means of screen printing. Using a rod-shaped magnet (150×25 mm²) on the lower glass side the ferromagnetic particles were aligned by means of the magnet and the resulting structure was hardened for 2 minutes by means of a UV-radiator. The burning-in of the paste was done simultaneously with a pre-stressing of the substrate at 710° C.

The layer thickness was 3.2 μm, the burnt-in paste was black, and in the region, where it was treated with a magnet, clearly a rod-shaped structure was visible.

### Example 5 (Comparative Example)

For producing a black paste with a viscosity of 500 cP at 140 rpm 40 g of a ground glass frit (glass N, particle size D90 <4 μm) was mixed with 10 g of black pigment (Black 33) and 100 g of commercially available screen printing oil. This paste was applied full-surface onto a 4 mm thick pane of lime-soda glass with a size of 200 mm×200 mm using screen printing. An electromagnet which had the shape of square of 50 mm×50 mm was now held onto the non-coated side of the glass. The pigment did not align along the magnetic fields. Thereafter the coated substrate was dried at 200° C. and was burnt-in at 650° C. for 10 minutes.

The layer thickness was 3.3 μm, the burnt-in paste was black, and in the range where it was treated with a magnet, no texture was visible.

### Example 6 (Comparative Example)

For producing a black paste with a viscosity of 500 cP at 140 rpm 40 g of a ground glass frit (glass N, particle size D90 <4 μm) was mixed with 10 g of black pigment (Black 27) and with 200 g of commercially available screen printing oil. This paste was applied full-surface onto a 4 mm thick pane of Borofloat® (trademark of the company Schott AG, Mainz) having a size of 200 mm×200 mm using screen printing. An electro-magnet that had the shape of a square of 50 mm×50 mm was now held against the non-coated side of the glass, and the pigment aligned in this region. After removing the magnet the edges of the square lost contour sharpness, and the texturing flow away. After removing the magnet the coated substrate was dried at 200° C. and was burnt-in at 650° C. for 10 minutes.

The layer thickness was 2.7 μm, the burnt-in paste was black, and in the region, where it was treated with the magnet, the square was no longer clearly visible.

1. A method of producing a substrate with a glass-based coating comprising the following steps:
providing a substrate;
preparing a paste from a glass frit to which ferromagnetic pigments and a flux agent are admixed, wherein a solid proportion of the paste comprises at least 5 wt.-% up to a maximum of 60 wt.-% of ferromagnetic pigments;
applying the paste onto a surface of the substrate;
aligning the paste by means of a magnetic field; and
burning-in the paste.

2. The method of claim 1, wherein iron-containing pigment are admixed as ferromagnetic pigments that may further comprise at least one element selected from the group consisting of O, Mn, Cr, Co, Ni, Zn, and Ti.

3. The method of claim 1, wherein iron-containing pigments are added as ferromagnetic pigments which are selected from the group consisting of (according to the color-index-classes) Black 26, Black 27, Black 30, Red 101, and mixtures thereof.

4. The method of claim 1, wherein further to the paste there is admixed at least one selected from the group consisting of color-providing pigments, additives, structure-providing particles, and mixtures thereof.

5. The method of claim 4, wherein to the paste color-providing pigments configured as metal oxides are added which are selected from the group consisting of cobalt-oxides/spinels, cobalt-aluminum-spinels, cobalt-aluminum-zinc-oxides, cobalt-aluminum-silicon-oxides, cobalt-titanium-spinels, cobalt-chromium-spinels, cobalt-aluminum-chromium-oxides, cobalt-nickel-manganese-iron-chromium-oxides/spinels, cobalt-nickel-zinc-titanium-aluminum-oxides/spinels, chromium-iron-nickel-manganese-oxides/-spinels, cobalt-iron-chromium-oxides/spinels, nickel-iron-chromium-oxides/spinels, iron-manganese oxides/spinels, iron-oxides, iron-chromium-oxides, iron-chromium-tin-titanium-oxides, copper-chromium-spinels, nickel-chromium-antimony-titanium-oxides, titanium-oxides, zirconium-silicon-iron-oxidesispinels, and mixtures thereof.

6. The method of claim 1, wherein to the paste in addition pigments configured as absorption pigments are added.

7. The method of claim 1, wherein to the paste in addition fillers are added which are selected from the group consisting of SiO₂-particles, aluminum oxide particles, pyrogenic silicic acids, lime-soda glass spheres, alcaline-aluminosilicate glass spheres, borosilicate glass spheres, hollow glass spheres, polysiloxane spheres, and mixtures thereof.

8. The method of claim 1, wherein the paste is prepared with a solid proportion of 15-35 wt.-% of ferromagnetic pigments.

9. The method of claim 1, wherein the paste is prepared with a glass frit which is selected from the group consisting of alkaline-free and alkaline-containing glasses, silicate glasses, borosilicate glasses, zinc-silicate glasses, zinc-borate glasses, zinc-borosilicate glasses, bismuth-borosilicate glasses, bismuth-borate glasses, bismuth-silicate glasses, phosphate glasses, zinc-phosphate glasses, aluminosilicate glasses, or lithium-alumino-silicate glasses, and mixtures thereof.

10. A method of producing a substrate with a glass-based coating comprising the following steps:
providing a substrate;
preparing a paste from a glass frit to which ferromagnetic pigments and a flux agent are admixed, wherein a solid proportion of the paste comprises at least 5 wt.-% up to a maximum of 60 wt.-% of ferromagnetic pigments;
applying the paste onto a surface of the substrate;
aligning the paste by means of a magnetic field; and
burning-in the paste;
wherein a solid proportion of the paste is mixed with a flux agent configured as a liquid to a paste having a viscosity in the range of 1 to 2000 cP at 140 rpm.

11. The method of claim 10, wherein the solid proportion of the paste is mixed with a flux agent configured as a liquid to a paste having a viscosity in the range of 100 to 600 cP, at 140 rpm.

12. The method of claim 10, wherein the paste is prepared as a screen-printing color based on sol-gel.

13. The method of claim 10, wherein the paste, after application to the surface of the substrate, is aligned by means of a magnetic field and is dried thereafter, before the paste is burnt-in.

14. The method of claim 10, wherein the paste, after application onto the surface of the substrate, is aligned by means of a magnetic field and is simultaneously dried, before the paste is burnt-in.

15. The method of claim 10, wherein the paste is provided with UV-hardening additives which during or after the alignment of the paste by means of a magnetic field are hardened by means of UV-irradiation.

16. The method of claim 10, wherein the temperature during burning-in is above the softening temperature of the glass frit, and the coating during burning-in flows smoothly.

17. The method of claim 1, wherein a glass ceramic substrate is used which in the green state is coated with the paste and during burning-in is ceramized.

18. The method of claim 1, wherein a glass ceramic substrate is used which is coated with the paste in the already ceramized state and is fired thereafter for burning-in the coating.

19. A substrate comprising a burnt-in coating of a glass frit comprising ferromagnetic pigments which at least partially form a textured coating, prepared according to claim 1.

20. The substrate of claim 19, wherein said burnt-in glass frit comprises a solid solid proportion at least 5 wt.-% up to a maximum of 60 wt.-% of ferromagnetic pigments.
